(19) United States
(12) Patent Application Publication
(10) Pub. No.: US 2020/0330808 A1
(43) Pub. Date: Oct. 22, 2020

(54) METHOD AND APPARATUS FOR STABILIZING FIRE SUPPRESSION AGENTS IN SITU

(71) Applicant: Kidde Technologies, Inc., Wilson, NC (US)

(72) Inventors: Terry Simpson, Wake Forest, NC (US); Adam Chattaway, Old Windsor (GB)

(21) Appl. No.: 16/388,975

(22) Filed: Apr. 19, 2019

(51) Int. Cl. A62D 1/00; A62C 37/00; B01D 15/08

(52) U.S. Cl. CPC A62D 1/0014; B01D 15/08; A62C 37/00

(57) ABSTRACT

Disclosed herein is a method and apparatus for stabilizing a fire suppression agent, including: substantially continuously contacting a solid radical scavenging agent with a liquid fire suppression agent in a fire extinguisher, wherein the fire suppression agent comprises CF₃I.

### BACKGROUND

Exemplary embodiments of the present disclosure pertain to the art of fire suppression agent stabilization.

Halon 1301 has frequently been employed as a fire suppression agent but there is currently a desire to replace Halon 1301 with more environmentally friendly fire suppression agents or blends of agents. Some of the proposed alternatives to Halon 1301 are less stable than Halon 1301 so solutions must be found that will improve the stability of the alternative fire suppression agents and allow the alternative fire suppression agents to be stored in the fire extinguisher system for extended periods of time.

### BRIEF DESCRIPTION

Disclosed is a method for stabilizing a fire suppression agent, including: substantially continuously contacting a solid radical scavenging agent with a liquid fire suppression agent in a fire extinguisher, wherein the fire suppression agent comprises CF₃I.

In addition to one or more of the features described above, or as an alternative to any of the foregoing embodiments, the solid radical scavenging agent is located in a container having a plurality of openings sized to contain the solid radical scavenging agent within the container and the container is located in the fire extinguisher.

In addition to one or more of the features described above, or as an alternative to any of the foregoing embodiments, the solid radical scavenger includes a zeolite.

In addition to one or more of the features described above, or as an alternative to any of the foregoing embodiments, the zeolite may be coated with an additional radical scavenger.

In addition to one or more of the features described above, or as an alternative to any of the foregoing embodiments, the solid radical scavenging agent includes a solid support coated with a radical scavenger. The solid support may include glass beads, silica gel, mesh, or a combination thereof. The solid radical scavenging agent may further include a zeolite. The zeolite may be coated with a radical scavenger.

In addition to one or more of the features described above, or as an alternative to any of the foregoing embodiments, the method may further include contacting the fire suppression agent with a drying agent.

Also disclosed is an apparatus for stabilizing a fire suppression agent including a fire extinguisher bottle, and a container disposed in the fire extinguisher bottle and a solid radical scavenging agent disposed within the container, wherein the container has a plurality of openings to contain the solid radical scavenging agent within the container and allow substantially continuous contact with the fire suppression agent, and further wherein the container is removeably attached to the fire extinguisher bottle and the fire suppression agent comprises CF₃I.

In addition to one or more of the features described above, or as an alternative to any of the foregoing embodiments, the solid radical scavenging agent comprises a zeolite. The zeolite may be coated with an additional radical scavenger.

In addition to one or more of the features described above, or as an alternative to any of the foregoing embodiments, the solid radical scavenging agent includes a solid support coated with a radical scavenger. The solid support may include glass beads, silica gel, mesh, or a combination thereof. The solid radical scavenging agent may further include a zeolite. The zeolite may be coated with a radical scavenger.

### BRIEF DESCRIPTION OF THE DRAWINGS

The following descriptions should not be considered limiting in any way. With reference to the accompanying drawings, like elements are numbered alike:

FIG. 1 is a schematic representation of an apparatus for stabilizing a fire suppression agent.

### DETAILED DESCRIPTION

A detailed description of one or more embodiments of the disclosed apparatus and method are presented herein by way of exemplification and not limitation with reference to the FIGURE.

CF₃I and blends including CF₃I are an environmentally attractive alternative to fire extinguishing agents like Halon 1301 because CF₃I has a lower ozone depletion potential. The lower ozone depletion potential is due to the lower stability of the molecule. The lower stability (or the increased tendency to degrade) presents a challenge for long term storage of CF₃I or blends containing CF₃I as a fire suppression agent. CF₃I forms radicals as it degrades and these radicals can initiate further degradation and undesirable by products. One approach to resolving the storage problem is to substantially continuously contact the fire suppression agent with a solid radical scavenging agent. As used herein “substantially continuously contact” is defined as having the fire suppression agent in contact with the solid radical scavenging agent for at least 90% of the time that the fire suppression agent is stored in the fire extinguisher.

The fire suppression agent includes CF₃I optionally in combination with one or more of HFC-125, HCFO-1233zd(e), Novec 1230, and CO₂. When used in combination with another fire suppression agent the CF₃I may be present in an amount greater than or equal to 30 wt %, or, greater than or equal to 35 wt %, or, greater than or equal to 40 wt %, based on the total weight of the fire suppression agent. Exemplary combinations are shown in the following table.

| | |
|---|---|
| CF₃I | HFC-125 |
| 45 wt % | 55 wt % |
| CF₃I | Novec 1230 |
| 44 wt % | 56 wt % |
| CF₃I | HCFO-1233zd(e) |
| 65 wt % | 35 wt % |

In some embodiments the solid radical scavenger includes a zeolite. Exemplary zeolites include zeolites having a Si/Al molar ratio greater than 1, or, greater than or equal to 1.5, or, greater than or equal to 5. Any of the foregoing zeolites may sodium in the form of ions or atoms.

In some embodiments the zeolite is coated with an additional radical scavenger. Exemplary additional radical scavengers include copper, silver, and iodine donors such as high molecular weight alkyl iodide compounds, high molecular weight alkene iodide compounds and high molecular weight aromatic iodide compounds. High molecular weight iodide compounds have a melting point greater than 205° F.

In some embodiments the solid radical scavenger includes a solid support coated with a radical scavenger. Exemplary solid supports include glass beads, plastic beads, mesh, silica gel, and combinations thereof. The radical scavenger coating would include one or more of the additional radical scavengers listed in the paragraph above.

The solid radical scavenger would be present in an amount sufficient to stabilize the fire suppression agent for greater than or equal to 5 years, or, greater than or equal to 20 years. Exemplary amounts of solid radical scavenger are 0.1 to 1 weight percent based on the total amount of CF₃I.

It may be advantageous to combine the solid radical scavenging with a drying agent. The drying agent could facilitate water removal from the fire suppression agent and prevent freezing of the water during discharge which could result in blockage of the discharge apparatus.

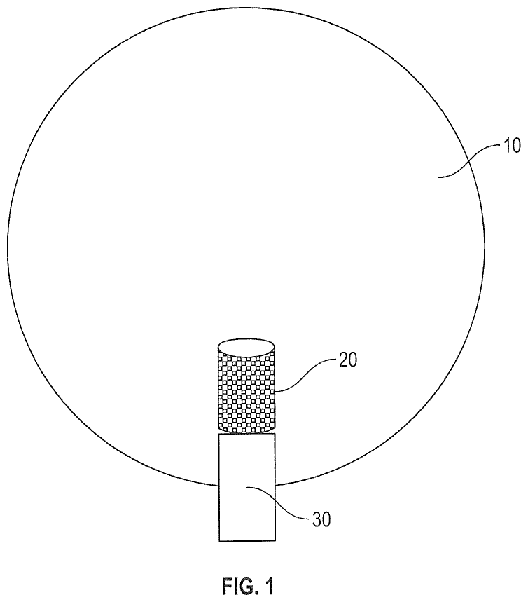

Turning now to FIG. 1, an exemplary apparatus for stabilizing a fire suppression agent is shown. The apparatus includes a fire extinguisher bottle, 10, and a container 20 disposed in the fire extinguisher bottle. The container is shown removeably attached to the fire extinguisher bottle via the discharge/fill apparatus 30 although the container may be removeably attached to another location in the fire extinguisher bottle.

In some embodiments the container 20 is a screen tube assembly made of mesh having a grid size small enough to retain the solid radical scavenger. In some embodiments the mesh of the container is the solid support which is coated with a solid radical scavenger.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method for stabilizing a fire suppression agent, comprising:
substantially continuously contacting a solid radical scavenging agent with a liquid fire suppression agent in a fire extinguisher, wherein the fire suppression agent comprises CF₃I and the solid radical scavenging agent is present in an amount of 0.1 to 1 weight percent based on the total amount of CF₃I.

2. The method of claim 1, wherein the solid radical scavenging agent is located in a container having a plurality of openings sized to contain the solid radical scavenging agent within the container and the container is located in the fire extinguisher.

3. The method of claim 1, wherein the solid radical scavenger comprises a zeolite.

4. The method of claim 3, wherein the zeolite is coated with an additional radical scavenger.

5. The method of claim 1, wherein the solid radical scavenging agent comprises a solid support coated with a radical scavenger.

6. The method of claim 5, wherein the solid support comprises glass beads, plastic beads, silica gel, mesh, or a combination thereof.

7. The method of claim 5, wherein the solid radical scavenging agent further comprises a zeolite.

8. The method of claim 7, wherein the zeolite is coated with an additional radical scavenger.

9. The method of claim 1, further comprising contacting the fire suppression agent with a drying agent.

10. An apparatus for stabilizing a fire suppression agent comprising:
a fire extinguisher bottle, and
a container disposed in the fire extinguisher bottle and a solid radical scavenging agent disposed within the container, wherein the container has a plurality of openings to contain the solid radical scavenging agent within the container and allow substantially continuous contact with the fire suppression agent, and further wherein the container is removably attached to the fire extinguisher bottle and the fire suppression agent comprises CF₃I and the solid radical scavenging agent is present in an amount of 0.1 to 1 weight percent based on the total amount of CF₃I.

11. The apparatus of claim 10, wherein the solid radical scavenging agent comprises a zeolite.

12. The apparatus of claim 11, wherein the zeolite is coated with an additional radical scavenger.

13. The apparatus of claim 10, wherein the solid radical scavenging agent comprises a solid support coated with a radical scavenger.

14. The apparatus of claim 13, wherein the solid support comprises glass beads, silica gel, mesh, or a combination thereof.

15. The apparatus of claim 13, wherein the solid radical scavenging agent further comprises a zeolite.

16. The apparatus of claim 15, wherein the zeolite is coated with an additional radical scavenger.
